(19) United States
(12) Patent Application Publication
(10) Pub. No.: US 2014/0087211 A1
(43) Pub. Date: Mar. 27, 2014

(54) MAGNETIC RECORDING MEDIUM COATING COMPOSITION AND MAGNETIC RECORDING MEDIUM

(71) Applicant: FUJIFILM CORPORATION, Tokyo (JP)

(72) Inventor: Kazufumi OMURA, Minami-ashigara-shi (JP)

(73) Assignee: FUJIFILM CORPORATION, Tokyo (JP)

(21) Appl. No.: 14/038,242

(22) Filed: Sep. 26, 2013

(30) Foreign Application Priority Data
Sep. 27, 2012 (JP) 2012-213643

(51) Int. Cl. G11B 5/733

(52) U.S. Cl. CPC G11B 5/733
USPC 428/832.4; 428/832; 106/287.18; 106/243; 523/181

(57) ABSTRACT

The magnetic recording medium coating composition includes carbon black; iron oxide; at least one organic solvent selected from the group consisting of methyl ethyl ketone, cyclohexanone, and isophorone; an organic tertiary amine selected from the group consisting of an aliphatic tertiary monoamine and an alicyclic tertiary amine; and an organic acid.

### CROSS-REFERENCE TO RELATED APPLICATIONS

This application claims the benefit of priority under 35 USC 119 to Japanese Patent Application No. 2012-213643 filed on Sep. 27, 2012, which is expressly incorporated herein by reference in its entirety.

### BACKGROUND OF THE INVENTION

1. Field of the Invention

The present invention relates to a magnetic recording medium coating composition, and more particularly, to a magnetic recording medium coating composition that permits the formation of a magnetic recording medium having a coating layer in which carbon black and iron oxide are dispersed to a high degree.

The present invention further relates to a magnetic recording medium having a coating layer formed of the above coating composition.

2. Discussion of the Background

Means of rapidly transmitting information have developed significantly in recent years, permitting the transmission of data and images comprising immense amounts of information. As this data transmission technology has improved, greater density recording has been required of recording and reproducing devices and recording media to record, reproduce, and store information.

In high-density recording, increasing the surface smoothness of the magnetic layer is effective for achieving good electromagnetic characteristics. Examples of methods of increasing the surface smoothness of the magnetic layer are the use of microparticulate magnetic powder and increasing dispersion of the microparticulate magnetic powder. Even when the microparticulate powder is dispersed to a high degree in the magnetic layer, when the surface smoothness of the nonmagnetic layer positioned beneath the magnetic layer is poor, the magnetic layer is affected by the roughness of the surface of the nonmagnetic layer and the smoothness of the surface of the magnetic layer decreases. Accordingly, to achieve a smoother magnetic layer surface, it is better to disperse the powder contained in the nonmagnetic layer to a high degree and to increase the smoothness of the surface of the nonmagnetic layer.

For example, a magnetic recording medium having a nonmagnetic layer containing iron oxide and carbon black is fabricated in Examples of Japanese Unexamined Patent Publication (KOKAI) No. 2007-287312 or English language family member US2007/224458 A1, which are expressly incorporated herein by reference in their entirety. The iron oxide that is employed is a nonmagnetic powder that facilitates the formation of a coating that is of good durability. Additionally, carbon black can be added to the nonmagnetic layer to perform functions such as preventing charge buildup in the magnetic recording medium. Thus, these two powders have been widely employed in combination as nonmagnetic layer components in recent years.

In Examples of Japanese Unexamined Patent Publication (KOKAI) No. 2007-287312, phenylphosphonic acid, a known dispersing agent that can enhance the dispersion of various powders, is employed as a component of the nonmagnetic layer along with the above two powders. However, based on investigation by the present inventor, the dispersion-enhancing effect of phenylphosphonic acid falls short of the degree of dispersion required to achieve the good surface smoothness required for a high-density recording medium.

### SUMMARY OF THE INVENTION

An aspect of the present invention provides for a means of dispersing carbon black and iron oxide to a high degree.

Carbon black has the peculiar property of aggregating to form a high-order structure called a “structure” in solvent. This is thought to be the main reason behind the difficulty encountered in enhancing dispersion in a nonmagnetic layer containing carbon black and iron oxide.

Accordingly, the present inventor conducted extensive research into discovering a means of increasing the dispersion of carbon black in a composition containing carbon black and iron oxide in solvent. As a result, he discovered that the combined use of carbon black; iron oxide; an organic solvent selected from the group consisting of methyl ethyl ketone, cyclohexanone, and isophorone; an organic tertiary amine selected from the group consisting of aliphatic tertiary monoamines and alicyclic tertiary amines; and an organic acid simultaneously enhanced the dispersion of carbon black and iron oxide in solvent.

The above point will be described in greater detail. It is known that hydrophilic moieties comprised of hydroxyl groups and carboxyl groups, as well as hydrophobic moieties comprised of carbon, with the hydrophobic moieties comprised of carbon being aromatic rings constituting a graphite structure, are present on the surface of carbon black (for example, see Setchaku no Gijutsu [Adhesion Technology], Vol. 30, No. 4 (2011), Serial Vol. 101, p. 5, Fig. 1.7, which is expressly incorporated herein by reference in its entirety). It is thought that the dispersion of carbon black can be enhanced by covering the hydrophilic moiety or the hydrophobic moiety with a compound having a unit with affinity for either the hydrophilic moiety or the hydrophobic moiety. However, carbon black ends up forming a structure in solvent before the hydrophilic moiety or hydrophobic moiety is covered, so that even when a compound having a unit with affinity for either of the moieties is added, it tends not to enhance dispersion by blocking the formation of the structure.

By contrast, in the above combination discovered by the present inventor, by using a solvent in which carbon black tends not to form a structure in the form of a solvent selected from the group consisting of methyl ethyl ketone, cyclohexanone, and isophorone, in combination with the above organic tertiary amine having affinity for the hydrophilic moiety, the organic tertiary amine was thought to cover the hydrophilic moiety on the surface of the carbon black, thereby blocking the formation of the structure. The present inventor presumed that it was possible to achieve a state of a high degree of carbon black dispersion in this manner.

The research conducted by the present inventor also revealed that it was possible to achieve high degrees of dispersion of both carbon black and iron oxide by employing iron oxide and an organic acid in the above combination.

The present invention was devised based on the above discoveries.

An aspect of the present invention relates to:

a magnetic recording medium coating composition, which comprises:

carbon black;

iron oxide;

at least one organic solvent selected from the group consisting of methyl ethyl ketone, cyclohexanone, and isophorone;

an organic tertiary amine selected from the group consisting of an aliphatic tertiary monoamine and an alicyclic tertiary amine; and

an organic acid.

In an embodiment, the above magnetic recording medium coating composition is a coating composition for forming a nonmagnetic layer of a magnetic recording medium comprising a nonmagnetic layer and a magnetic layer in this order on a nonmagnetic support.

In an embodiment, the aliphatic tertiary monoamine is denoted by formula (1):

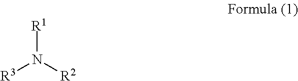

wherein, in formula (1), each of R¹, R², and R³ independently denotes a linear or branched alkyl group having 1 to 18 carbon atoms.

In an embodiment, in formula (1), each of R¹, R², and R³ independently denotes a linear or branched alkyl group having 1 to 8 carbon atoms.

In an embodiment, the organic solvent comprises methyl ethyl ketone and/or cyclohexanone.

In an embodiment, the organic acid is an aliphatic or aromatic compound.

In an embodiment, the organic acid comprises an acid group selected from the group consisting of a carboxyl group and a phosphonic acid group.

In an embodiment, the organic acid is a fatty acid.

In an embodiment, the above magnetic recording medium coating composition further comprises a binder resin.

In an embodiment, the binder resin is selected from the group consisting of a vinyl copolymer and a polyurethane resin.

A further aspect of the present invention relates to:

a magnetic recording medium, which comprises a coating layer that has been foamed with the above magnetic recording medium coating composition.

In an embodiment, the above magnetic recording medium comprises a nonmagnetic layer and a magnetic layer in this order on a nonmagnetic support, and the coating layer is the nonmagnetic layer.

An aspect of the present invention can provide a magnetic recording medium coating composition in which carbon black and iron oxide are dispersed to a high degree in a solvent. The magnetic recording medium coating composition according to an aspect of the present invention can be employed as is, or mixed with various additives that are employed to prepare a magnetic recording medium, to form a coating layer with good surface smoothness, desirably a nonmagnetic layer.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

### Magnetic Recording Medium Coating Composition

The magnetic recording medium coating composition, that is a coating composition for a magnetic recording medium, according to an aspect of the present invention can be used to manufacture a magnetic recording medium having a coating layer containing carbon black and iron oxide. The magnetic recording medium coating composition contains carbon black; iron oxide; at least one organic solvent selected from the group consisting of methyl ethyl ketone, cyclohexanone, and isophorone; an organic tertiary amine selected from the group consisting of aliphatic tertiary monoamines and alicyclic tertiary amines; and an organic acid. The coating layer can be a nonmagnetic layer positioned between a nonmagnetic support and a magnetic layer, or a backcoat layer provided on the surface of the nonmagnetic support opposite from that on which the magnetic layer is present.

It is advantageous for enhancing the surface smoothness of the nonmagnetic layer to use the magnetic recording medium coating composition according to an aspect of the present invention to form a nonmagnetic layer in which carbon black and iron oxide are dispersed to a high degree. As set forth above, enhancing the dispersion of the powder and increasing the surface smoothness of the nonmagnetic layer can increase the surface smoothness of the magnetic layer and contribute to enhancing the electromagnetic characteristics thereof in the high-density recording region.

The magnetic recording medium coating composition according to an aspect of the present invention (also referred to simply as the “composition”, hereinafter) will be described in greater detail below.

### Carbon Black

The carbon black that is contained in the composition according to an aspect of the present invention can be suitably selected from those usually employed for magnetic recording media. It can be selected for use based on the application from among various carbon blacks such as furnace black for rubber, thermal for rubber, black for coloring, electrically conductive carbon black, acetylene black. With regard to carbon black suitable for use in an aspect of the present invention, reference can be made to the Carbon Black Handbook (compiled by the Carbon Black Association, which is expressly incorporated herein by reference in its entirety, for example.

In a particulate magnetic recording medium, carbon black can be mixed into the nonmagnetic layer to achieve the known effect of reducing surface resistivity Rs and optical transmittance, and achieving a desired micro-Vicker's hardness. A lubricant stockpiling effect can also be achieved by incorporating carbon black into the nonmagnetic layer. The specific surface area, measured by the nitrogen adsorption method, of the carbon black that is employed in the nonmagnetic layer is normally 50 to 500 m²/g, desirably 70 to 400 m²/g, and the DBP oil absorption capacity is normally 20 to 400 mL/100 g, desirably 30 to 400 mL/100 g. The average primary particle diameter of the carbon black that is employed in the nonmagnetic layer is normally 5 to 80 nm, desirably 10 to 50 nm, and preferably, 10 to 40 nm.

The surface resistance and light transmittance of the backcoat layer can be set low by adding microparticulate carbon black to the backcoat layer of a particulate magnetic recording medium. Since many magnetic recording devices utilize the light transmittance of the tape for an operating signal, adding microparticulate carbon black is particularly effective in such cases. In the microparticulate carbon black that is employed in the backcoat layer, it is desirable for the average primary particle diameter to fall within a range of 5 to 30 nm, the specific surface area to fall within a range of 60 to 800 m²/g, the DBP oil absorption capacity to fall within a range of 50 to 130 mL/100 g, and the pH to fall within a range of 2 to 11.

Reference can be made to, for example, paragraphs [0033] and [0053] of Japanese Patent No. 4149648, which is expressly incorporated herein by reference in its entirety, for details on the above carbon blacks. Carbon black can be used within a range, for example, of 1 to 100 weight parts per 100 weight parts of iron oxide. In a composition comprising a relatively large quantity of carbon black, such as a composition comprising equal to or greater than 30 weight parts of carbon black per 100 weight parts of iron oxide, the dispersion of carbon black is particularly difficult. However, the present invention makes it possible to increase the dispersion of carbon black in a composition containing a relatively high amount of carbon black along with iron oxide.

### Organic Solvent

The essential solvent in the composition according to an aspect of the present invention is selected from the group consisting of methyl ethyl ketone, cyclohexanone, and isophorone. When employing a solvent other than these essential solvents, it is desirable to mix the carbon black and the organic tertiary amine in the above essential solvent in advance to cover the surface of the carbon black with the organic tertiary amine. Thus, even when another solvent is subsequently added, the dispersion of the carbon black will remain good.

Among the above essential solvents, the incorporation of at least methyl ethyl ketone and/or cyclohexanone is desirable from the perspective of the dispersion-enhancing effect on carbon black. The above essential solvents can be employed singly or in combinations of two or more in any ratio. Methyl ethyl ketone, cyclohexanone, and isophorone are all readily available, and are thus widely employed as organic solvents in the area of manufacturing magnetic recording media. Methyl ethyl ketone and cyclohexanone have relatively low boiling points and are highly safe, making them easy to handle.

The composition according to an aspect of the present invention can contain solvents other than the above essential solvents. In that case, the essential solvents desirably account for equal to or greater than 50 weigh percent, preferably 50 to 95 weigh percent, of the total solvent weight. Examples of solvents that can be employed in combination are ether solvent, ester solvents, ketone solvents, and various other solvents. Specific examples of ketone solvents that can be employed in combination are acetone, methyl isobutyl ketone, and diisobutyl ketone. However, aromatic solvents such as benzene, toluene, and xylene could potentially promote the formation of carbon black structures and are thus desirably not employed in combination. When they are employed in combination, they are desirably kept to less than 5 weight percent of the total solvent weight.

### Organic Tertiary Amine

The composition according to an aspect of the present invention contains at least one organic tertiary amine selected from the group consisting of an aliphatic tertiary monoamine and an alicyclic tertiary amine. No aromatic group is directly bonded to the nitrogen atom in either aliphatic tertiary monoamines or alicyclic tertiary amines. In an aspect of the present invention, such an organic tertiary amine is employed because in tertiary amines in which an aromatic group is directly substituted onto the nitrogen atom, it is difficult to increase the degree of dispersion of the carbon black even when the above organic solvent is also employed. That is because tertiary amines in which an aromatic group is directly substituted onto the nitrogen atom are presumed to exhibit a poor ability to selectively adsorb to hydrophilic portions on the surface of the carbon black.

It is desirable to employ, as the aliphatic tertiary monoamine, the aliphatic tertiary monoamine denoted by formula (1) below to further increase the dispersion of carbon black.

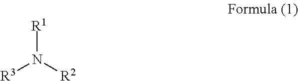

In formula (1), each of R¹, R², and R³ independently denotes a linear or branched alkyl group having 1 to 18 carbon atoms. The alkyl group can be unsubstituted, or can have substituents. Examples of substituents are alkyl groups (such as alkyl groups having 1 to 6 carbon atoms), hydroxyl groups, alkoxyl groups (such as alkoxyl groups having 1 to 6 carbon atoms), halogen atoms (such as fluorine atoms, chlorine atoms, and bromine atoms), and aryl groups (such as phenyl groups). The “number of carbon atoms” when a substituent is present means the number of carbon atoms of the portion excluding the substituent. In the present invention, the range indicator “to” indicates an inclusive range from the preceding minimum value to the succeeding maximum value. In formula (1), R¹, R², and R³ may all be of the same structure, or may be different. As set forth above, tertiary amines in which an aromatic group is directly substituted onto the nitrogen atom are presumed to have poor ability to selectively adsorb to hydrophilic portions on the surface of the carbon black. It is conceivable that the adsorption of aromatic groups to hydrophobic portions of carbon black hinders the amine portions from covering the hydrophilic portions. When an aromatic group is incorporated as a substituent of an alkyl group, the aromatic group is linked to the amine through an alkylene group. By using an intermediate alkylene group, the amine portion can be free to rotate. Thus, it is thought that even if the aromatic group adsorbs to the hydrophobic portion of the carbon black, the amine group is not hindered by it and can adsorb to the hydrophilic portion. That is presumed to be because an aliphatic tertiary monoamine containing an aromatic group as a substituent on the alkyl group, in combination with a prescribed solvent, can achieve a state of high carbon black dispersion.

The number of carbon atoms of the alkyl group falls within a range of 1 to 18, desirably within a range of 1 to 10, and preferably within a range of 1 to 8. The above range is desirable because it permits carbon black to be dispersed to a higher degree in the above solvent. The alkyl group can be linear or branched.

The aliphatic ring contained in the above alicyclic tertiary amine can be a saturated or unsaturated, monocyclic, bridged, or condensed aliphatic ring. The aliphatic ring is desirably a four to eight-membered ring, preferably a five to seven-membered ring, to further enhance carbon black dispersion. Alicyclic tertiary amines in which multiple nitrogen atoms form an amidine structure within the ring are desirable in that they further enhance the dispersion effect. It is thought that basicity is intensified by the presence of an amidine structure.

Specific desirable examples of the above-described organic tertiary amine are triethylamine, N,N-diisopropylethylamine, tripropylamine, tributylamine, triamylamine, trihexylamine, triheptylamine, trioctylamine, 1,8-diazabicyclo[5.4.0]undec-7-ene (DBU), N,N-dimethylbenzylamine, N-butyldiethanolamine, hexamethylenetetramine, and the like.

From the perspective of further enhancing the dispersion of carbon black, the organic tertiary amine is desirably employed in a proportion of 1 to 50 weight parts, preferably 1 to 20 weight parts, per 100 weight parts of carbon black. For the same reason, the total quantity of solvent is desirably 100 to 1,000 weight parts per 100 weight parts of the total quantity of carbon black and iron oxide in the composition according to an aspect of the present invention.

### Iron Oxide

Iron oxide that is commonly employed as a nonmagnetic powder in a magnetic recording medium, such as α-iron oxide, can be employed as the iron oxide. It is desirably acicular in form. From the perspective of forming a coating layer having good surface smoothness by dispersion to a high degree, the average particle diameter desirably falls within a range of 5 to 500 nm, preferably within a range of 10 to 200 nm. From the same perspective, the specific surface area by the BET method is desirably 1 to 150 m²/g, preferably 20 to 120 m²/g, and more preferably, 50 to 100 m²/g. The oil absorption capacity using dibutyl phthalate (DBP) is, for example, 5 to 100 mL/100 g, desirably 10 to 80 mL/100 g, and still more preferably, 20 to 60 mL/100 g. The specific gravity is, for example, 1 to 12, desirably 3 to 6. The tap density is, for example, 0.05 to 2 g/mL, desirably 0.2 to 1.5 g/mL. When the tap density falls within a range of 0.05 to 2 g/mL, there will be few scattering particles, handling will be good, and device adhesion will tend not to occur. The pH of the iron oxide is desirably 2 to 11, preferably 6 to 9. Within a pH range of 2 to 11, it is possible to prevent a rise in the coefficient of friction due to free fatty acids, high temperature, and high humidity. The iron oxide can be surface treated so that Al₂O₃, SiO₂, TiO₂, ZrO₂, SnO₂, Sb₂O₃, and ZnO are present on the surface. Al₂O₃, SiO₂, TiO₂, and ZrO₂ are desirable for dispersion and Al₂O₃, SiO₂, and ZrO₂ are preferable. These can be combined for use, or employed individually. Based on the objective, it is possible to employ a surface treated layer that has been coprecipitated. The method of treatment with alumina followed by a silica surface treatment, and the reverse, can be adopted. Based on the objective, the surface treated layer can be a porous layer, although a homogenous, dense surface layer is generally desirable.

### Organic Acid

An organic acid in the form of an organic compound exhibiting acidity, desirably an organic compound having one or more acid groups selected from the group consisting of a carboxyl group, phosphonic acid group, and phosphoric acid group, is desirable. Embodiments in which an organic acid is contained in the form of a salt such as an alkali metal salt, are included in the composition according to an aspect of the present invention. These organic acids can be organic compounds such as aliphatic, aromatic, and alicyclic organic compounds. Of these, from the perspective of enhancing the dispersion of the iron oxide without diminishing the dispersion of carbon black, an aliphatic or aromatic compound having an acid group selected from the group consisting of a carboxyl group and a phosphonic acid group is desirable and a fatty acid is preferable. Examples of desirable organic acids are fatty acids such as oleic acid and aromatic acids such as phenylphosphonic acid.

The organic acid is desirably employed in a proportion of 1 to 10 weight parts per 100 weight parts of iron oxide from the perspective of enhancing the dispersion of the iron oxide without diminishing the dispersion of carbon black.

The method of coating the surface of microparticles with a binder resin is a common method of enhancing the dispersion of microparticles. However, by using the above essential components and an essential solvent along with carbon black and iron oxide in the composition according to an aspect of the present invention, it is possible to achieve a high state of dispersion of carbon black and iron oxide even when a binder resin is not employed. Incorporating a binder resin into the composition according to an aspect of the present invention makes it possible to disperse carbon black and iron oxide to an even higher degree. Examples of binder resins that can be employed are binder resins that are commonly employed in magnetic recording media, such as polyurethane resins, polyester resins, polyamide resins, vinyl chloride resins, acrylic resins in which styrene, acrylonitrile, methyl methacrylate and the like are copolymerized, nitrocellulose, other cellulose resins, epoxy resins, phenoxy resins, polyvinyl acetal, polyvinyl butyral, and other polyvinyl alkylal resins. Of these, vinyl copolymers and polyurethane resins are desirably employed. The binder resin can be employed, for example, in a proportion of 1 to 100 weight parts per 100 weight parts of carbon black.

The average particle size of powders such as carbon black, iron oxide and the like in the present invention can be measured by the following method.

Particles of powder are photographed at a magnification of 100,000-fold with a model H-9000 transmission electron microscope made by Hitachi and printed on photographic paper at a total magnification of 500,000-fold to obtain particle photographs. The targeted particle is selected from the particle photographs, the contours of the particle are traced with a digitizer, and the size of the particles is measured with KS-400 image analyzer software from Carl Zeiss. The size of 500 particles is measured. The average value of the particle sizes measured by the above method is adopted as an average particle size of the powder.

The size of a powder (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method. As in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

The average powder size of the powder is the arithmetic average of the above powder size and is calculated by measuring five hundred primary particles in the above-described method. The term “primary particle” refers to a nonaggregated, independent particle.

The composition according to an aspect of the present invention can be prepared by simultaneously or sequentially mixing the above-described carbon black, iron oxide, essential solvent, organic tertiary amine, and organic acid, and additional components as needed.

### Magnetic Recording Medium

A further aspect of the present invention relates to a magnetic recording medium, which comprises a coating layer that has been formed with the above magnetic recording medium coating composition.

The magnetic recording medium coating composition according to an aspect of the present invention set forth above can comprise carbon black and iron oxide in a highly dispersed state. Thus, the composition can be coated and dried as is, or as a mixture with additives known in the manufacturing of magnetic recording media, directly or through one or more additional layers, on the surface of a nonmagnetic support to obtain a coating layer affording good surface smoothness without surface roughness caused by the aggregation of carbon black and iron oxide.

One embodiment of the coating layer is a nonmagnetic layer or backcoat layer of a magnetic recording medium. When the coating layer is a nonmagnetic layer, a magnetic layer-forming coating composition can be coated and dried thereover by a known simultaneous or sequential multilayer coating method to form a magnetic layer affording good surface smoothness. In this manner, it is possible to obtain a magnetic recording medium affording good electromagnetic characteristics in the high-density recording region.

In the layer structure of the magnetic recording medium according to an aspect of the present invention, the thickness of the nonmagnetic support is desirably 3 to 80 μm. The thickness of the magnetic layer can be optimized based on the saturation magnetization level and head gap length of the magnetic head employed and the bandwidth of the recording signal. From the perspective of achieving a high capacity, the thickness of the magnetic layer is desirably 10 to 100 nm, preferably 20 to 80 μm. It suffices to have at least one magnetic layer, and it does not matter if the magnetic layer is separated into two or more layers having different magnetic properties; known configurations for multilayered magnetic layers can be applied. The thickness of the nonmagnetic layer is desirably 0.6 to 3.0 μm, preferably 0.6 to 2.5 μm, and more preferably, 0.6 to 2.0 μm. The thickness of the backcoat layer is desirably equal to or less than 0.9 μm, preferably 0.1 to 0.7 μm.

When the magnetic recording medium according to an aspect of the present invention has a nonmagnetic layer, the nonmagnetic layer will produce its effect so long as it is essentially nonmagnetic. The effect of the present invention will be achieved even if impurities or small quantities of magnetic material are intentionally incorporated into the nonmagnetic layer, and such configurations can be viewed as being essentially identical to the magnetic recording medium according to an aspect of the present invention. The term “essentially identical” means that the residual flux density of the nonmagnetic layer is equal to or less than 10 mT (100 G) and the coercivity is equal to or less than 7.96 kA/m (100 Oe), and desirably means that no residual flux density or coercivity is present.

With the exception that at least one layer is a coating layer that is formed using the magnetic recording medium coating composition according to an aspect of the present invention, known techniques relating to magnetic recording media, including the techniques described in above-cited Japanese Unexamined Patent Publication (KOKAI) No. 2007-287312 and Japanese Patent No. 4,149,648, can be applied without limitation in the magnetic recording medium according to an aspect of the present invention.

### EXAMPLES

The present invention will be described in detail below based on Examples. However, the present invention is not limited to the examples.

### Example 1

To a solution comprised of 7.4 weight parts of methyl ethyl ketone (2-butanone) and 5.0 weight parts of cyclohexanone were suspended 1 weight part of the nonmagnetic powder described below, 0.53 weight part of the carbon black described below, 0.27 weight part of vinyl chloride resin, 0.18 weight part of polyurethane resin, 0.046 weight part of an organic acid in the form of phenylphosphonic acid, and 0.021 weight part of an amine in the form of triethyl amine. To the suspension were added 50 weight parts of 0.1 mm φ zirconia beads (made by Nikkato) and the mixture was dispersed for 15 minutes to obtain a dispersion.

Measurement of the diameter (particle diameter in liquid by the dynamic light scattering method) of the dispersed particles by the method described further below gave a value of 70 nm.

The dispersion was coated with a doctor blade having a 19 μm gap on a PEN base made by Teijin Corp. and left standing for 30 minutes at room temperature to fabricate a coating film. The average roughness of the coating film that was fabricated was 2.1 nm as measured by the method set forth further below.

Carbon black: #950 made by Mitsubishi Chemical Corp.
Average primary particle diameter: 18 nm
Specific surface area by nitrogen adsorption method: 260 m²/g
DBP oil absorption capacity: 79 mL/100 g (powder form)
pH: 7.5

Nonmagnetic powder (α-Fe₂O₃ hematite)
Average major axis length: 0.15 μm
Specific surface area by BET method: 52 m²/g
pH: 6
Tap density: 0.8
DBP oil absorption capacity: 27 to 38 g/100 g
Surface treatment agent: Al₂O₃, SiO₂

Method of Measuring Dispersed Particle Diameter (Particle Diameter in Liquid by Dynamic Light Scattering Method)

The carbon dispersion was diluted with the same organic solvent as that employed in dispersion to a solid component concentration of 0.2 weight percent (the solid component denoted the combined weight of the carbon black, iron oxide, organic acid, amine additive, and binder resin.).

The average particle diameter as measured with an LB-500 dynamic light scattering particle size analyzer made by Horiba for the diluted liquid obtained was adopted as the dispersed particle diameter. The smaller the dispersed particle diameter, the better the dispersion without aggregation of carbon black and iron oxide indicated.

Method of Measuring Surface Roughness of Coating Film

Measurement was conducted at a scan length of 5 μm by the scanning white light interference method with a general purpose three-dimensional surface structure analyzer in the form of a New View 5022 made by ZYGO Corp. The object lens was 20-fold, the intermediate lens was 1.0-fold, and the measurement viewing field was 260 μm×350 μm. The measured surface was filter-processed with an HFP: 1.65 μm, 50 μm filter to obtain the center line average surface roughness Ra.

### Examples 2 to 5

With the exceptions that the type of organic acid as well as type and quantity of amine were changed as indicated in Table 1 below, dispersions and coating films were fabricated and evaluated by the same methods as in Example 1.

### Comparative Example 1

With the exception that no amine was employed, a dispersion and coating film were fabricated and evaluated by the same methods as in Example 1.

Evaluation results for Examples and Comparative Example are given in Table 1 below.

TABLE 1

| | | | | | Particle | Surface |
|---|---|---|---|---|---|---|
| | Type of | Quantity of | | Quantity of | diameter in | roughness |
| | organic acid | the acid* | Type of amine | amine* | liquid [nm] | [nm] |
| Ex. 1 | Phenylphosphonic | 0.046 | Triethylamine | 0.021 | 70 | 2.1 |
| | acid | | | | | |
| Ex. 2 | Oleic acid | 0.069 | Trioctylamine | 0.022 | 53 | 1.5 |
| Ex. 3 | Oleic acid | 0.031 | Trioctylamine | 0.022 | 60 | 1.5 |
| Ex. 4 | Oleic acid | 0.069 | Trioctylamine | 0.045 | 45 | 1.5 |
| Ex. 5 | Oleic acid | 0.069 | DBU | 0.028 | 47 | 1.8 |
| Comp. | Phenylphosphonic | 0.046 | — | | 110 | 9.7 |
| Ex. 1 | acid | | | | | |

*Quantity (weight part) added relative to 1 weight part of iron oxide

Based on the results given in Table 1 above, the combination of an organic tertiary amine selected from the group consisting of aliphatic tertiary monoamines and alicyclic tertiary amines; a solvent selected from the group consisting of methyl ethyl ketone, cyclohexanone, and isophorone; and an organic acid made it possible to disperse carbon black and iron oxide to a high degree in solvent, and thus to form a coating film of high surface smoothness.

The present invention is useful in the field of manufacturing magnetic recording media.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium coating composition, which comprises:
carbon black;
iron oxide;
at least one organic solvent selected from the group consisting of methyl ethyl ketone, cyclohexanone, and isophorone;
an organic tertiary amine selected from the group consisting of an aliphatic tertiary monoamine and an alicyclic tertiary amine; and
an organic acid.

2. The magnetic recording medium coating composition according to claim 1, which is a coating composition for forming a nonmagnetic layer of a magnetic recording medium comprising a nonmagnetic layer and a magnetic layer in this order on a nonmagnetic support.

3. The magnetic recording medium coating composition according to claim 1, wherein the aliphatic tertiary monoamine is denoted by formula (1): 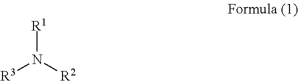
wherein, in formula (1), each of R¹, R², and R³ independently denotes a linear or branched alkyl group having 1 to 18 carbon atoms.

4. The magnetic recording medium coating composition according to claim 3, wherein, in formula (1), each of R¹, R², and R³ independently denotes a linear or branched alkyl group having 1 to 8 carbon atoms.

5. The magnetic recording medium coating composition according to claim 1, wherein the organic solvent comprises methyl ethyl ketone and/or cyclohexanone.

6. The magnetic recording medium coating composition according to claim 1, wherein the organic acid is an aliphatic or aromatic compound.

7. The magnetic recording medium coating composition according to claim 1, wherein the organic acid comprises an acid group selected from the group consisting of a carboxyl group and a phosphonic acid group.

8. The magnetic recording medium coating composition according to claim 1, wherein the organic acid is a fatty acid.

9. The magnetic recording medium coating composition according to claim 1, which further comprises a binder resin.

10. The magnetic recording medium coating composition according to claim 9, wherein the binder resin is selected from the group consisting of a vinyl copolymer and a polyurethane resin.

11. A magnetic recording medium, which comprises a coating layer that has been formed with a magnetic recording medium coating composition comprising:
carbon black;
iron oxide;
at least one organic solvent selected from the group consisting of methyl ethyl ketone, cyclohexanone, and isophorone;
an organic tertiary amine selected from the group consisting of an aliphatic tertiary monoamine and an alicyclic tertiary amine; and
an organic acid.

12. The magnetic recording medium according to claim 11, wherein the magnetic recording medium comprises a nonmagnetic layer and a magnetic layer in this order on a nonmagnetic support, and the coating layer is the nonmagnetic layer.

13. The magnetic recording medium according to claim 11, wherein the aliphatic tertiary monoamine is denoted by formula (1): 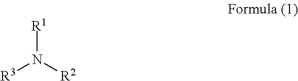
wherein, in formula (1), each of R¹, R², and R³ independently denotes a linear or branched alkyl group having 1 to 18 carbon atoms.

14. The magnetic recording medium according to claim 13, wherein, in formula (1), each of R¹, R², and R³ independently denotes a linear or branched alkyl group having 1 to 8 carbon atoms.

15. The magnetic recording medium according to claim 11, wherein the organic solvent comprises methyl ethyl ketone and/or cyclohexanone.

16. The magnetic recording medium according to claim 11, wherein the organic acid is an aliphatic or aromatic compound.

17. The magnetic recording medium according to claim 11, wherein the organic acid comprises an acid group selected from the group consisting of a carboxyl group and a phosphonic acid group.

18. The magnetic recording medium according to claim 11, wherein the organic acid is a fatty acid.

19. The magnetic recording medium according to claim 11, wherein the coating layer further comprises a binder resin.

20. The magnetic recording medium according to claim 19, wherein the binder resin is selected from the group consisting of a vinyl copolymer and a polyurethane resin.
